(19) United States
(12) Patent Application Publication
(10) Pub. No.: US 2014/0315407 A1
(43) Pub. Date: Oct. 23, 2014

(54) ADAPTER CONVERTING CFL BASE TO MEDIUM BASE OR OTHER SOCKETS MADE IN THE LIGHTING/ELECTRICAL INDUSTRIES

(71) Applicant: William Richards, JR., Buford, GA (US)

(72) Inventor: William Richards, JR., Buford, GA (US)

(21) Appl. No.: 14/219,413

(22) Filed: May 9, 2014

Related U.S. Application Data
(60) Provisional application No. 61/803,568, filed on Mar. 20, 2013.

(51) Int. Cl. H01J 5/54

(52) U.S. Cl. CPC H01J 5/54
USPC 439/234; 439/236

(57) ABSTRACT

The present invention is an adapter with a first section having a base with standard compact fluorescent lamp (CFL) bi/quad pins formed thereon. A second section of the adapter has a socket for receiving an incandescent bulb, an LED bulb or other types of base sockets. The socket has a vertical telescoping section to allow the bulb to move relative to the base. A second embodiment of the invention has the socket positioned at a 90 degree angle relative to the base, and further having a knuckle and a horizontal telescoping section allowing the bulb to be repositioned when the adapter is used in recess housing. Additional embodiments utilize an electric pigtail in communication with the base to mount to a variety of lighting fixtures.

### BACKGROUND OF INVENTION

The present invention relates to a bi (quad) pin base integrally formed with a medium base (Edison screw) socket for accepting an LED bulb or other types of base sockets made in the lighting/electrical industries.

Due to energy concerns the number of lighting fixtures adapted to accept CFLs has increased substantially in recent years. Non-integrated CFLS use a bi-pin or quad base to connect to the CFL base in lighting fixtures or any type of base sockets made in the lighting/electrical industries. Standard incandescent bulbs and LED bulbs are connectable to a medium (Edison screw) base or other types of base sockets.

### SUMMARY OF THE INVENTION

The general purpose of the present invention, which will be described subsequently in greater detail, is to provide new and improved lighting device mountable to the socket of any existing recessed compact fluorescent lamps (CFLs) lighting fixtures or sockets.

The invention is an adapter with a first section having a base with standard compact fluorescent lamp (CFL) bi/quad pins formed thereon. A second section of the adapter has a socket for receiving an incandescent bulb, an LED bulb or other types of base sockets. The adapter delivers electricity to the bulbs.

The socket has a vertical telescoping section to allow the bulb to move relative to the base. Springs may be constructed on the base to support the weight of the bulb.

A second embodiment of the invention has the socket positioned at a 90 degree angle relative to the base, and further having a knuckle and horizontal telescoping section allowing the bulb to be repositioned when the adapter is used in recess housing.

Additional embodiments of the invention utilize an electric pigtail in electrical communication with the base to mount to a variety of lighting fixtures.

### BRIEF DESCIPTION OF THE DRAWINGS

The invention will be better understood and objects other than those set forth above will become apparent when consideration is given to the following detailed description thereof. Such description makes reference to the annexed drawings wherein:

FIG. 1 is an exploded view of a first embodiment of an adapter comprising the present invention.

FIG. 2 is an exploded view of a second embodiment of the adapter comprising the invention.

FIG. 3 is a top plan view of the second embodiment.

FIG. 4 is a top plan view of the second embodiment with a knuckle allowing movement of the adapter and being rotated to a first position.

FIG. 5 is a view of the second embodiment in a second position.

FIG. 6 is a perspective view of the first embodiment in use and mounted in a lighting fixture.

FIG. 7 is a view of the second embodiment of the invention in use and being mounted in a lighting fixture.

FIG. 8 is a view of a third embodiment of the invention in use.

FIG. 9 is a view of a fourth embodiment of the invention in use.

FIG. 10 is a view of a fifth embodiment of the invention in use.

### DETAILED DESCRIPTION OF THE INVENTION

Referring to the drawings in general, an embodiment of the present invention 10 will now be described in greater detail.

The adapter 10 includes first section having a base 12 having a first end and a second end with bi/quad pin(s) 14 formed on the outer wall of the base 12 at the first end. The base 12 consists of a standard compact fluorescent lamp (CFL) bi/quad pin(s) base well known in the industry and used with electronic ballasts permanently installed in lighting fixtures when the pins are engaged. The adapter 10 further comprises a second section having a socket 16 with a first end and a second end being adaptable to removeably receive an incandescent bulb or LED bulb 18 or any other type of base made in the electrical/lighting industries. The socket 16 is well known in the industry to those skilled in the art. The second end of the socket 16 is adapted to receive and deliver electricity to the light bulbs 18 by having an opening with threads, or any type of base sockets made in the lighting/electrical industries, to removeably engage the threads of the bulbs 18. The second end of the base 12 is integrally formed both mechanically and electronically with the first end of the socket 16. Inside the socket 16 at the first end is a central contact to provide electricity to the bulb 18 when the bulb has been screwed into place.

The socket 16 has a vertical telescoping section 20 to allow the bulb to be moved in and out relative to the base 12. Optionally, clips 22 are constructed at the second end of the base to support the weight of the bulbs 18.

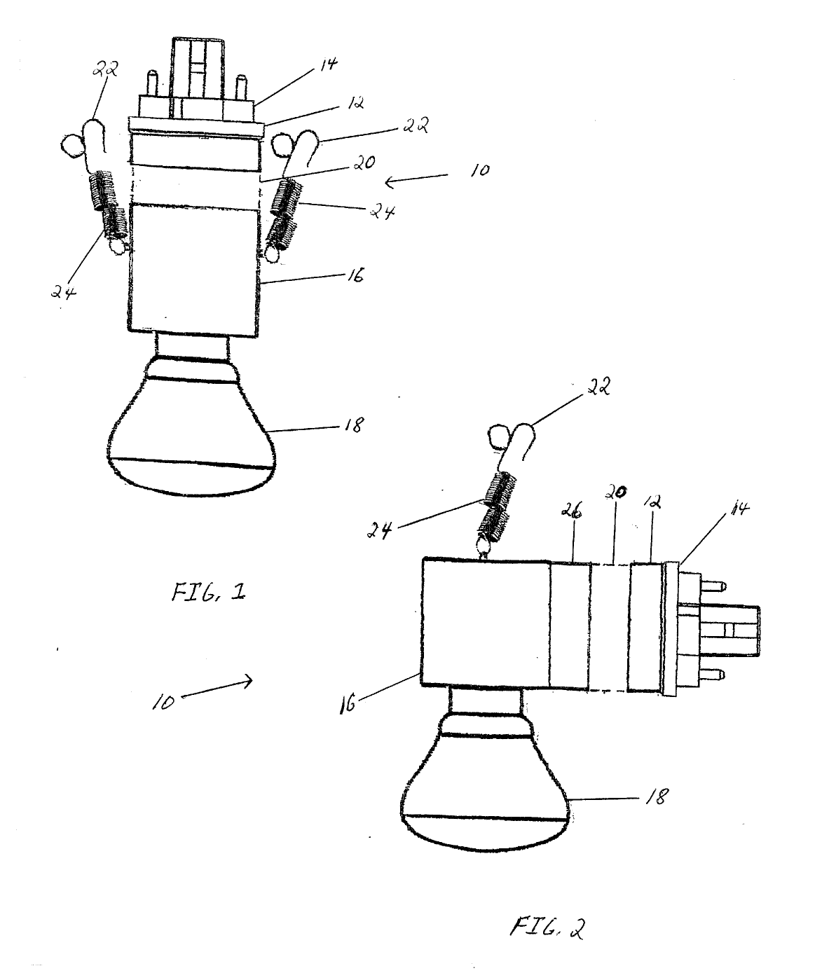

FIG. 2 illustrates a second embodiment of the adapter 10 wherein the second end of the socket 16 is positioned at a 90 degree angle relative to the base 12. The second embodiment is used to center the bulb 18 in recess housing by allowing the base 12 to be mounted in the CFL lighting fixture horizontally. The clips 22 and telescoping section 20 are also present in the second embodiment. Springs 24 are provided to support the adapter 10 as needed.

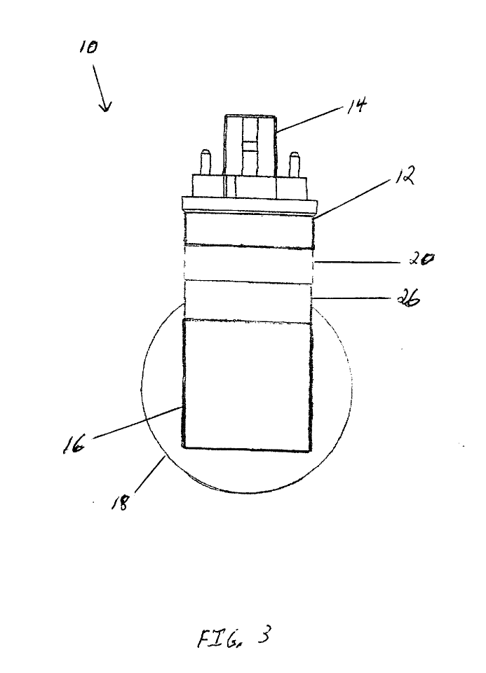

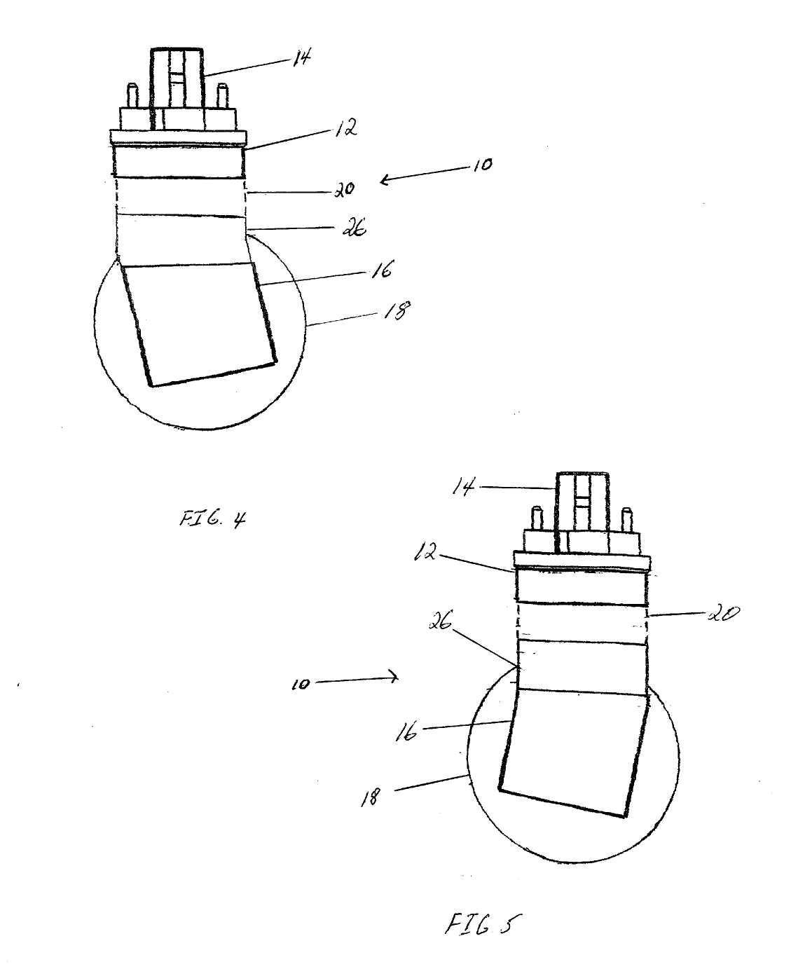

FIGS. 3-5 illustrate the second embodiment of the adapter 10 having a joint 26 which allows the bulb 18 to be positioned in multiple positions when the second embodiment is used in recess housing. FIG. 3 illustrates the bulb in the central position. In FIGS. 4 and 5 the bulb 18 is positioned to the right and left respectively.

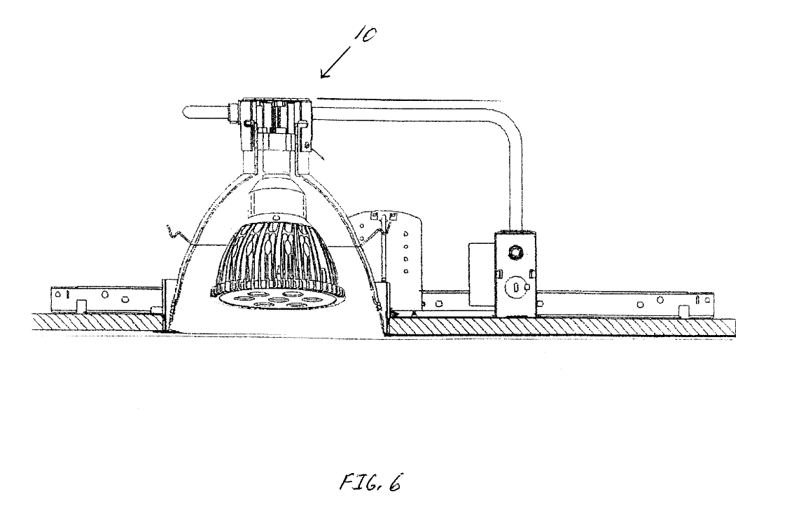

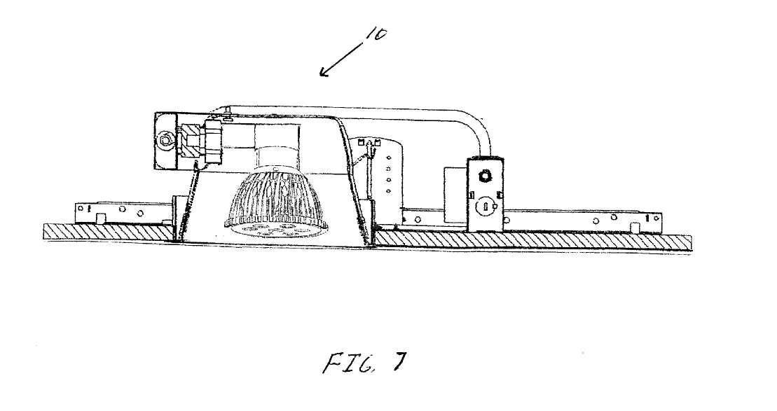

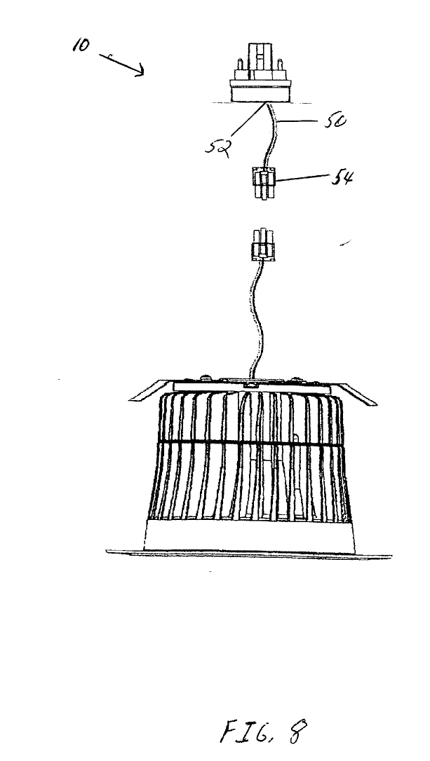

FIGS. 6 and 7 illustrate the adapter 10 in use and mounted to standard CFL socket present in recessed CFL lighting fixtures. After the adapter 10 is mounted in the fixture the bulb is engaged with the socket 16. It can be readily seen that LED bulbs, incandescent bulbs or any other type of base made in the electrical/lighting industry can be replaced as needed, and that the adapter can be vertically inserted or horizontally inserted as needed depending upon the position of the CFL socket in the fixture.

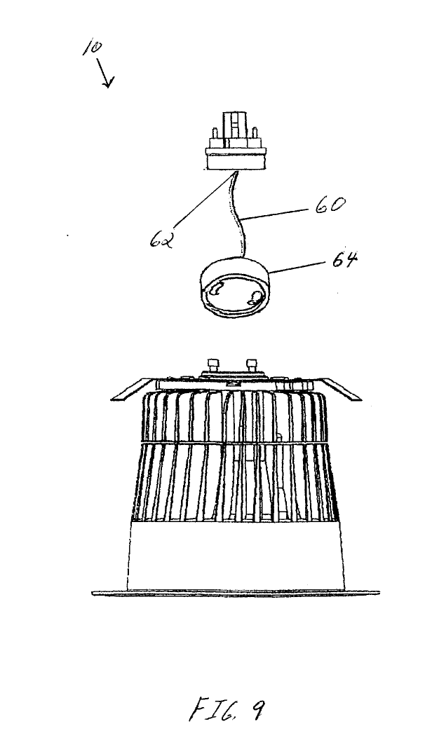

A third embodiment of the adapter 10 is illustrated in FIG. 8. An electronic pigtail 50, having a first end and a second end, is connected for electronic communication with the base 12 of the adapter 10. Contact wires 52 formed at the first end of the electronic pigtail 50 are permanently connected to the base 12 by soldering the wires 52 to base metal of G24Q and GX24 sockets (or comparable types of base sockets) integrally formed in the base 12. An electrical connector 54 is crimped and compressed to the second end of the electronic pigtail 50. A lighting fixture mateable with the electrical connector 54 is in electrical communication with the adapter 10.

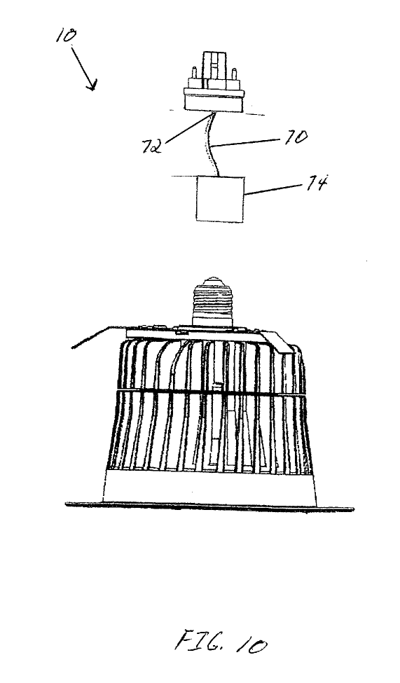

A fourth embodiment of the adapter 10 is illustrated in FIG. 9. An electronic pigtail 60, having a first end and a second end, is connected for electronic communication with the base 12 of the adapter 10. Contact wires 62 formed at the first end of the electronic pigtail 60 are permanently connected to the base 12 by soldering the wires 62 to base metal of G24Q and GX24 sockets (or comparable types of base sockets) integrally formed in the base 12. The second end of the electronic pigtail 60 is affixed to the base metal of a GU24 connector 64. The GU24 connector 64 is configured for mounting compact fluorescent light bulbs (CFL) that use a bayonet mount bi-pin connector. The connector 64 allows the overall length of the bulb to be shorter than the Edison screw fitting used on incandescent light bulbs.

A fifth embodiment of the adapter 10 is illustrated in FIG. 10. An electronic pigtail 70, having a first end and a second end, is connected for electronic communication with the base 12 of the adapter 10. Contact wires 72 formed at the first end of the electronic pigtail 70 are permanently connected to the base 12 by soldering the wires 72 to base metal of G24Q and GX24 sockets (or comparable types of base sockets) integrally formed in the base 12. The second end of the electronic pigtail 60 is affixed to the base metal of a medium base (Edison) socket 74, well known in the industry.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description only and should not be regarded as limiting the scope and intent of the invention.

I claim:

1. An adapter for converting compact fluorescent lamp base, comprising in combination:
a base having a first end and a second end, whereby compact fluorescent lamp pins are integrally formed on an outer wall of the base at the first end;
a socket having an inner surface, an outer surface, a first end and a second end, whereby the first end of the socket is electronically connected to the second end of the base, and the inner surface of the second end of the socket is configured to receive outwardly threaded light bulbs;
a first support member having a clip comprised of hooked end and a shank depending from the hooked end, and springs with a first end attached to the shank, with a second end affixed to the outer surface of the socket; and
a second support member having a clip comprised of hooked end and a shank depending from the hooked end, and springs with a first end attached to the shank, with a second end affixed to the outer surface of the socket opposed the first support member.

2. The adapter as set forth in claim 1, further comprising an extendable telescoping section having a first end affixed to the second end of the base and a second end affixed to the first end of the socket.

3. An adapter for converting compact fluorescent lamp base, comprising in combination:
a base having a first end and a second end, whereby compact fluorescent lamp pins are integrally formed on an outer wall of the base at the first end;
a socket having an inner surface, an outer surface, a first end and a second end, whereby the socket is aligned perpendicular to the base and is electronically connected to the second end of the base, and the inner surface of the second end of the socket is configured to receive outwardly threaded light bulbs;
a rotatable joint affixed to the socket;
a first support member having a clip comprised of hooked end and a shank depending from the hooked end, and springs with a first end attached to the shank, with a second end affixed to the outer surface of the socket; and
a second support member having a clip comprised of hooked end and a shank depending from the hooked end, and springs with a first end attached to the shank, with a second end affixed to the outer surface of the socket opposed the first support member.

4. The adapter as set forth in claim 3, further comprising an extendable telescoping section having a first end affixed to the second end of the base and a second end affixed to the first end of the socket.

5. An adapter for converting compact fluorescent lamp base, comprising in combination:
a base having a first end and a second end, whereby compact fluorescent lamp pins are integrally formed on an outer wall of the base at the first end; and
electric wiring having a first end and a second end, whereby the first end of the wiring is permanently connected electronically to the second end of the base and an electrical connector mateable with a lighting fixture is affixed to the second end of the wiring.

6. The adapter as set forth in claim 5, whereby the electrical connector is configured to mount compact fluorescent light bulbs using a bayonet mount bi-pin connector.

7. The adapter as set forth in claim 5, whereby the electrical connector is a socket having an inner surface, an outer surface, a first end and a second end, electronically connected to the second end of the base at its first end, and the inner surface of the second end of the socket is configured to receive outwardly threaded light bulbs.
